(19) United States
(12) Patent Application Publication
(10) Pub. No.: US 2026/0044193 A1
(43) Pub. Date: Feb. 12, 2026

(54) SELECTIVE AND SECURE IMPLEMENTATION OF FAN OPERATIONAL PROFILES

(71) Applicant: Cisco Technology, Inc., San Jose, CA (US)

(72) Inventors: Paolo Sironi, Gallarate (Va) (IT); Gilberto Loprieno, Milan (IT); Davide Finardi, Mozzanica (BG) (IT)

(21) Appl. No.: 18/990,581

(22) Filed: Dec. 20, 2024

Related U.S. Application Data
(60) Provisional application No. 63/680,322, filed on Aug. 7, 2024.

(51) Int. Cl. G06F 1/20; G06F 21/44; H05K 7/20

(52) U.S. Cl. CPC G06F 1/206; G06F 21/44; H05K 7/20709

(57) ABSTRACT

Methods, apparatuses, and systems provide cooling equipment, such as fans, that may operate according to a selected profile of a plurality of operational profiles. An authentication process may be performed with respect to the fan and/or with respect to an operational control to verify the operations of the fan. A system is provided that includes one or more electronic modules configured to perform one or more operations and at least one fan configured to cool the one or more electronic modules by operating at a predetermined speed based on an operational profile. The system further includes a controller configured to securely communicate with the at least one fan to control the at least one fan to select the operational profile from a plurality of operational profiles.

### CROSS-REFERENCE TO RELATED APPLICATION

This application claims the benefit of priority under 35 U.S.C. § 119(e) to U.S. Provisional Application No. 63/680,322, filed on Aug. 7, 2024, which is hereby incorporated by reference in its entirety.

### TECHNICAL FIELD

The present disclosure generally relates to fan control and operations.

### BACKGROUND

Cooling equipment such as a fan, provides cooling to a device, component, and/or system as a result of heat generated by electrical circuitry or processors. A fan may direct an air flow to cool the heat generating components via convection. Fans are used in a variety of fields including optical transport devices. In the optical transport systems, the devices that are used by service providers need to operate within a wide temperature range, altitude, and subject to humidity constraints. Additionally, service providers may use cooling equipment to meet these constraints as well as to protect against any possible single point of failure i.e., to prevent a system thermal shutdown in case of a failure. Web service operators, on the other hand, have a more limited temperature variation but are more sensitive to power consumption and acoustic noise. To support these different types of applications, different cooling equipment (e.g., fans) are designed and used, and this can be wasteful and cumbersome. Additionally, cooling equipment can be vulnerable to hacker attacks, which may result in thermal shutdown of the system or excessive power consumption, for example.

### BRIEF DESCRIPTION OF THE DRAWINGS

FIG. 1 is a block diagram illustrating a chassis that includes a fan system that securely selects one of a plurality of operational profiles, according to an example embodiment.

FIGS. 2A, 2B, 2C, 2D, 2E, and 2F are charts representing operational profiles, which may be available for selection by a fan system of FIG. 1, according to a first example embodiment and a second example embodiment.

FIG. 3 is flowchart of a method of selecting, via a digital interface, one of operational profiles for controlling operations of the fan, according to a first example embodiment.

FIGS. 4A and 4B are flow diagrams for methods of selecting, via a pulse width modulation connection, one of a plurality of operational profiles for controlling operations of the fan, according to a second example embodiment.

FIG. 5 is a flowchart of a method of authenticating a fan based on information stored in a trusted platform module, according to an example embodiment.

FIG. 6 is a flowchart of a method of authenticating operational control of a fan, according to an example embodiment.

FIG. 7 is a flowchart of a method of controlling an operation of a fan based on selecting one of a plurality of operational profiles, according to an example embodiment.

FIG. 8 is a hardware block diagram of a computing device that may perform functions associated with any combination of operations in connection with the techniques depicted and described in FIGS. 1-7, according to various example embodiments.

### DETAILED DESCRIPTION

### Overview

Methods, apparatuses, and systems provide cooling equipment, such as fans, that may operate according to a selected profile of a plurality of operational profiles. An authentication process may be performed with respect to the fan and/or with respect to an operational control to verify the operations of the fan.

In one form, a system is provided that includes one or more electronic modules configured to perform one or more operations and at least one fan configured to cool the one or more electronic modules by operating at a predetermined speed based on an operational profile. The system further includes a controller configured to securely communicate with the at least one fan to control the at least one fan to select the operational profile from a plurality of operational profiles.

In another form, a method performed by a fan is provided. The method includes obtaining, from a controller, an authenticated control signal that identifies an operational profile from a plurality of operational profiles. The method further includes switching the fan to the operational profile based on the authenticated control signal and controlling an operation of the fan by setting the fan at a predetermined speed based on the operational profile.

In yet another form, an apparatus is provided. The apparatus includes a fan controller configured to store a plurality of operational profiles and a communication interface configured to securely communicate with a system controller to obtain a control signal that enables the fan controller to select an operational profile from the plurality of operational profiles. The apparatus further includes a fan motor configured to rotate to provide cooling to one or more electronic modules that perform one or more operations, wherein the fan controller sets the fan motor to a predetermined speed in the operational profile based on the control signal.

### Example Embodiments

Operation of a fan, such as fan speed or power consumed, may be adjusted to change the cooling provided by the fan. Different types of fan operations may be more suitable for different applications of a fan. Fans may be deployed in various applications that have significantly different operating conditions and/or demands. For example, a first application (e.g., a network and/or service provider application) may include greater temperature ranges (e.g., −5 degrees Celsius to 60 degrees Celsius), impose altitude and humidity constraints (e.g., for operation at 1800 meters above sea level), be associated with environmental compliance restrictions, and/or include greater cooling demands. A second application (e.g., a web service operator application) has a limited temperature variation but is sensitive to power consumption and acoustic noise. Therefore, the same fan operation (e.g., same fan speed, same fan power) may not be suitable for both applications. A fan may operate at a higher speed threshold in the first application but this higher fan speed threshold may be detrimental in the second application. It may be difficult and/or costly to re-design a system that limits the speed of the fan in the second application below the speed threshold (e.g., via a circuit breaker/fuse).

In related art, system controllers (e.g., proportional-integral-derivative (PID) controllers) may be designed, manufactured, and provided for respective applications to control fans based on their specific applications. Each system controller is dedicated for controlling a fan in a particular type of applications. However, producing multiple system controllers is costly (e.g., maintaining stock quantity for each), time consuming, and resource intensive (e.g., dedicating multiple manufacturing lines). Thus, adjusting fan operation based on a fan application without having to produce different system controllers for the fans may provide benefits associated with more suitably operating a fan.

According to one or more example embodiments, an operational profile (e.g., from a plurality of available operational profiles) may be selected for a fan to operate suitably in its application. As used herein, an operational profile (e.g., an operational curve) refers to an operation of a fan in response to an input control signal. In particular, each operational profile defines a relationship between a fan operating parameter (e.g., a fan speed, a fan power, etc.) and the input control signal. Within each operational profile, a value of the operating parameter may vary as the input control signal value changes. For instance, a greater input control signal value may generally cause the fan to operate at a higher speed within the operational profile or curve.

Different operational profiles may define different relationships between the operating parameter and the input control signal value. For example, a first operational profile may cause a fan to operate at a higher speed in response to receiving an input control signal value, whereas a second operational profile may cause the fan to operate at a lower speed in response to receiving the same input control signal value. Therefore, different operational profiles may cause the fan to operate differently (e.g., operate at different speeds) via the same input control signal provided by a system controller. In this manner, the same operation (control signal output) of a system controller causes the fan to operate differently based on the selected operational profile.

Each operational profile may be more suitable for a particular fan application. Therefore, a particular operational profile may be provisioned within a fan based on application of the fan to operate the fan more suitably for that application. As such, a single implementation of a system controller may support multiple different fan applications, because the fan operates according to a suitable operational profile based on the application in which the fan is to be deployed/used. The fan may be provisioned with a selected operational profile without any additional hardware equipment. Instead, a system controller may provide a control signal for selecting one of the plurality of operational profiles via a digital interface, such as inter-integrated circuit (I2C) interface.

In one example embodiment, the operational profile may be selected via a pulse width modulation (PWM) connection. The PWM connection may be used to adjust the speed of the fan within an operational profile but is modified to include a control signal for selecting one of the operational profiles. This design may be particularly suitable for a smaller fan that may not have the I2C interface.

Additionally, each operation profile may specify a default speed/power for the fan in an event of failure. In related art, in the event of failure, the fan is operated at a maximum speed. In one or more example embodiments, the maximum speed for a failure event is different depending on the selected operational profile. As such, even in the event of failure, the fan operates differently and more appropriately based on a particular application type.

In related art, the fans are also vulnerable from a security standpoint. For example, if the authenticity of a fan is not verified, a counterfeit fan may be installed. The counterfeit fan may cause reputation damage to the manufacturer. As another example, fan operational control may be subject to hacker attacks. That is, a hacker may physically drive the PWM signal and control the fan at undesirable speeds and/or power consumption levels.

In one or more example embodiments, the fan includes an authentication device (i.e., a trusted platform module (TPM)) that is used to authenticate the fan and/or its operations. In this way, if the fan is not an authentic fan, its operations are restricted. For example, at system startup, or fan removal/insertion, the system software (also protected by a secure boot and relevant security features) verifies the authenticity of the fan by reading the authentication device. In case of a mismatch, the fan generates an alarm and stops the system functionality.

Furthermore, in one or more example embodiments, the fan may be securely provisioned with multiple profiles using encryption techniques. The authentication device may store encryption keys such that operational profiles downloaded onto the fan have to be signed. If an unauthorized entity tries to install a fake operational profile for the fan, it would be identified as fake (not properly signed) and the fake operational profile could not be loaded/installed and/or used by the fan.

In one example embodiment, enabling a controller to install a particular operation profile is based on information programmed in a secure identity (secure unique device identifier or SUDI) i.e., of the authentication device or the trusted platform module. The fan reads the proportional-integral-derivative (PID) from the SUDI certificate (after its authentication) and enables the upload of a specific operational curve (operational profile) based on the PID. As an example, PID1 enables Curve 1 with feature set 1 and PID2 enables Curve 2 with feature set 2. As such, a secure boot of operational profile(s) is enabled.

Additionally, in one or more example embodiments, operational control of the fan by the system controller also involves authentication i.e., by using an encrypted digital interface. The encrypted digital interface may be a secure I2C interface. That is, I2C bus includes read and write protection by encrypting data/signals transmitted via the I2C bus. Encryption keys may be stored in the authentication device (i.e., the trusted platform module).

As such, in one or more example embodiments, security vulnerabilities of a fan are addressed. Authentication of the hardware component (fan) may eliminate use of a counterfeit fan. The secure boot of operational profile(s) ensures that hackers cannot install improper operational curves for the fan. Moreover, secure operations of the fan are enabled using an encrypted digital bus/interface.

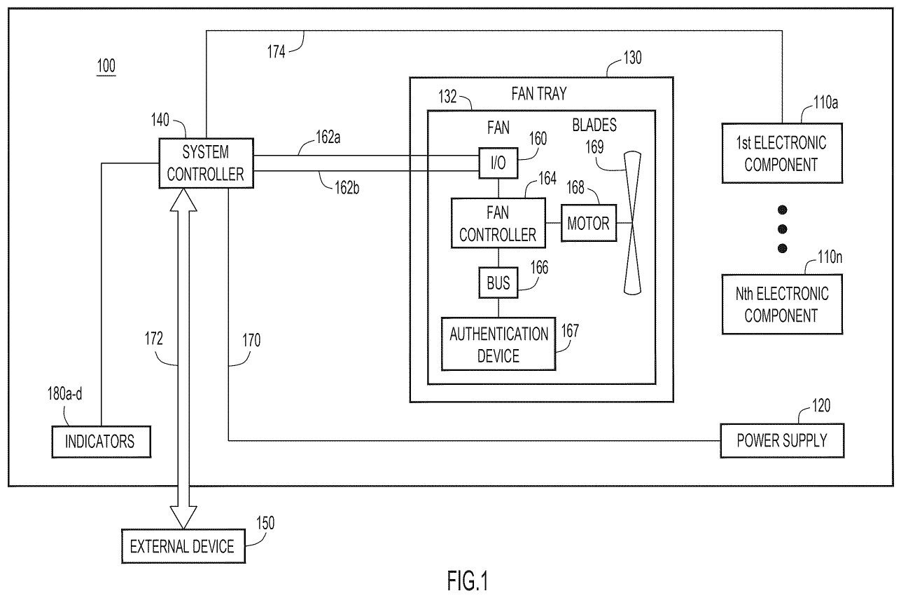

With reference made to FIG. 1, FIG. 1 illustrates a block diagram of a chassis (or housing) 100 that includes a fan system that securely selects one of a plurality of operational profiles, according to an example embodiment. The chassis 100 houses various electronic components 110a-n such as a first electronic component 110a and a nth electronic component 110n. The chassis 100 further includes a power supply 120 that provides power to the electronic components 110a-n and a fan tray 130 to cool the electronic components 110a-n. The chassis 100 may further include indicators 180a-d that provide visual notifications about the state of one or more components in the chassis 100. The entities in the chassis 100 are controlled by a system controller 140. The system controller 140 may connect with an external device 150 via an external connection 172 for further control and/or configuration. The system controller 140 is further connected to the fan tray 130 via fan connections 162a-b, to the power supply 120 via a power interface 170, and the electronic components 110a-n via component connections 174.

The notations 1, 2, 3 . . . n; a, b, c, . . . n; “a-n”, “a-d”, “a-f”, “a-g”, “a-k”, “a-b”, and the like illustrate that the number of elements can vary depending on a particular implementation and is not limited to the number of elements being depicted or described. Moreover, this is only examples of various components, and the number and types of components, functions, etc. may vary based on a particular deployment and use case scenario.

One example of the chassis 100 may be a “pizza box” chassis that uses a stackable, modular design (wide and flat) that resembles a pizza box. The chassis 100 may include one or more rack units (RUs). The chassis 100 may be deployed in a data center, in one example. For example, the chassis 100 may be a housing, an enclosure, or RU(s). The type of chassis 100 and electronic components stored therein (as well as the number of RUs) may vary based on a particular deployment and use case scenario. In one example embodiment, the chassis 100 may house multiple network switch or router cards/modules.

In one or more example embodiments, the chassis 100 includes receptacles for a plurality of pluggable modules that are configured to plug therein. These pluggable modules may be the various electronic components 110a-n i.e., modular electronic equipment. For example, the first electronic component 110a and the nth electronic component 110n may be line cards and/or fabric cards that are arranged in the chassis 100. The electronic components 110a-n may include a printed circuit board with application specific integrated circuit (ASIC) and other circuits. The electronic components 110a-n are configured to perform specific functions such as processing operations and/or storing data. The system controller 140 controls the electronic components 110a-n via the component connections 174.

The electronic components 110a-n may be artificial intelligence (AI) processing modules, graphic processing units (GPUs), data processing units (DPUs), optical transceiver modules, network processing unit (NPUs), central processing units (CPUs), a storage units (memories), etc. These are just some examples of the electronic components 110a-n that may be installed within the chassis 100. The electronic components 110a-n may include any modular equipment including network devices (e.g., switches, routers, etc.) and processors. The electronic components 110a-n installed in the chassis 100 depend on the actual deployment and use case scenario. The electronic components 110a-n may be removable from the chassis 100. The chassis 100 may be part of a chassis stack forming an integrated router modular design.

The electronic components 110a-n need power to operate, which may be provided by the power supply 120. The power supply 120 may include any power sources/power supply units that may supply high voltage direct current (HVDC), alternating current (AC), etc. The power supply 120 may further supply power to the fan tray 130.

For example, the fan 132 includes an authentication device 167 such as the trusted platform module that stores an authentication certificate for checking and validating an authenticity of a hardware in the fan 132 prior to enabling operations of the fan 132. Based on a failure of an authenticity process of the hardware in the fan 132, the system controller 140 generates an alarm i.e., using the indicators 180a-d and disables the fan 132 by shutting down the power from the power supply 120. That is, a component of the chassis 100 may be enabled or disabled by shutting down or supplying power from the power supply 120.

The electronic components 110a-n may generate heat and are cooled by cooling equipment, such as the fan tray 130, which may be removably installed in the chassis 100. While only one fan tray is shown in FIG. 1, this is just an example. Multiple fan trays may be installed in the chassis 100. Also, the chassis 100 may include one or more fans (e.g., an individual fan) instead of the fan tray 130.

The fan tray 130 includes one or more fans. As an example, the fan tray 130 includes the fan 132. The fan 132 includes an input/output (I/O) port 160, fan connections 162a-b that connect the fan 132 to the system controller 140. The fan connections 162a-b may include a digital interface 162a (e.g., an inter-integrated circuit (I2C) interface) and a PWM connection 162b (a wire for carrying a PWM signal for PWM control techniques), a fan controller 164 (e.g., a microcontroller) for controlling components of the fan 132, an internal communication bus 166, the authentication device 167, a motor 168 that rotates blades 169 that force air onto the electronic components 110a-n.

The I/O port 160 may include an interface with various pin connections, such as a ground pin, a pin for receiving an input control signal (e.g., a PWM signal), one or more pins (e.g., an inter-integrated circuit (I2C) bus that includes an I2C serial data pin and a I2C serial clock pin) for receiving fan data (e.g., manufacturing data, fan inventory data, etc.), a pin (e.g., a voltage common collector pin) for receiving power, and/or a pin for outputting data. For example, the fan controller 164 may output a square wave having a frequency related to fan speed to indicate a reading of a current fan speed). The I/O port 160 may be communicatively coupled to the system controller 140 to enable the system controller 140 to operate the fan tray 130, i.e., to establish a secure communication interface. For instance, the system controller 140 may provide an input control signal to the fan 132 via the digital interface 162a and/or the PWM connection 162b and the I/O port 160. The input control signal(s) may be transmitted from the I/O port 160 to the fan controller 164 (e.g., via the internal communication bus 166) to control a speed of the fan 132 and/or power consumption of the fan 132. The fan controller 164 sets the motor 168 (fan motor) to rotate at a predetermined speed in accordance with a selected operational profile to provide cooling to electronic components 110a-n that perform one or more operations.

The fan 132 operates according to one of a plurality of operational profiles. As an example, for different operational profiles, the fan 132 may operate at different speeds and/or power in response to receiving the input control signal provided by the system controller 140. As another example, for different operational profiles, the fan 132 may operate at a different speed during a fault condition (in an event of failure). For instance, the fault condition may cause the fan 132 to operate at a high speed (e.g., a maximum speed that the fan is rated to provide), which may cause the fan 132 to draw more power (e.g., a maximum amount of power the fan is rated to consume) and produce greater acoustic noise. In any case, each operational profile may be more suitable for a particular application of the fan 132, such as for limiting the speed/power/acoustic noise even during a fault condition and/or controlling a system fault. For example, in cases in which the input control signal is faulty (e.g., at zero or at a very limited value, such as less than 20% duty cycle), the speed/power/acoustic noise may be limited to that configured for the provisioned operational profile, as a default operational profile or default speed.

In one or more example embodiments, the system controller 140 may cause the fan controller 164 to operate according to an operational profile by transmitting a control signal to cause a read/write operation of the internal communication bus 166 to implement a particular operational profile. The system controller 140 further controls the power supply 120 via the power interface 170, to supply power to the entities of the chassis 100 such as the electronic components 110a-n and the fan tray 130. For example, as noted above, the trusted platform module stores an authentication certificate for checking and validating an authenticity of a hardware in the fan 132 prior to enabling operations of the at least one fan. As such, based on a failure of an authenticity process of the hardware in the fan 132, the system controller may generate an alarm using the indicators 180a-d and disable the fan 132 by shutting down the power from the power supply 120.

In one example embodiment, the external device 150 may be one or more temperature and/or humidity sensor(s) that are configured to sense the environment around the chassis 100 and report environmental condition(s) to the system controller 140. As an example, based on the external device 150 detecting that temperature increased and reporting the same to the system controller 140 via the external connection 172, the system controller 140 may control the fan tray 130 to increase the speed of each fan (e.g., supply a PWM signal to the fan 132) in accordance with the selected operational profile.

In additional or alternative example embodiments, the external device 150 (e.g., a user device, such as a mobile phone, a tablet, a computer) separate from the system controller 140 may be used to cause the fan controller 164 to operate according to a specific operational profile. As an example, a default operational profile may be initially implemented for the fan 132, and an input signal (e.g., transmitted by the system controller 140 or transmitted by the external device 150) may override the default operational profile and select a different operational profile to be implemented. In certain example embodiments, the fan 132 is configured to store different operational profiles (e.g., in a memory of the fan controller 164) available for selection. Additionally or alternatively, the system controller 140 and/or the external device 150 are each configured to transmit an operational profile to the fan 132 for implementation. In either case, the operational profile provisioning for the fan 132 may be performed by determining a current operational profile used by the fan 132, implementing another operational profile specific to the application of the fan 132, operating the fan 132 according to the operational profile, and verifying the operation of the fan 132 (e.g., based on output data provided by the fan 132).

The fan system may also be used to protect operations of the fan 132, such as to authenticate the fan 132 and/or the operational control thereof. For instance, the fan protection techniques presented herein may block an undesirable input control signal from operating the fan 132 and/or block an incompatible fan from operating with the system controller 140. For example, based on a failure of an authenticity process of the hardware in the fan 132, the system controller 140 may generate an alarm and disable the fan 132 by shutting down the power from the power supply 120. In either case, the fan system promotes desirable operation of the fan 132 (e.g., at a particular fan speed) in response to the input control signal.

To this end, the fan 132 may include the authentication device 167 (e.g., the trusted platform module or a trust anchor module), which may be a part of the internal communication bus 166. In certain example embodiments, the authentication device 167 is used to verify an identity (e.g., authenticity) of the fan 132 e.g., to check and validate authenticity of the hardware in the fan 132. In additional or alternative example embodiments, the authentication device 167 is used to authenticate the system controller 140 and/or the external device 150. In some implementations, the authentication device 167 is a separate module that can be installed in/on the fan 132. In such implementations, the identity of the authentication device 167 may also be verified (e.g., via a certificate, such as an X.509 certificate, stored in the authentication device 167) by the fan controller 164, the system controller 140, and/or the external device 150. Based on checking and validating, the system controller 140 may enable or disable operations of the fan 132 e.g., by shutting down the power from the power supply 120 or by enabling supply of power from the power supply 120.

The system controller 140 is further configured to control indicators 180a-d. The indicators 180a-d provide visual notifications about the state of various components in the chassis 100. For example, one of the indicators 180a-d may be configured to provide a visual notification about the state of the fan tray 130 and/or the fan 132 such that the indicator provides a first notification when the fan 132 is properly functioning, a second notification when the fan 132 is properly installed but not authenticated, and a third notification when the fan is faulty. For example, one of the indicators 180a-d may be a light emitting diode (LED) controlled to turn green, yellow, and red for each notification type. This is just one example. In another example, the indicators 180a-d may provide a visual notification about the selected profile and/or current speed of the fan 132 within an operational curve. For example, one of the indicators 180a-d may be LED is controlled to blink green at a first predetermined interval that indicates that a first operational profile is selected, at a second predetermined interval that indicates that a second operational profile is selected, and a steady green light indicating a default profile, etc. These are just some examples of the notifications that may be provided using the indicators 180a-d.

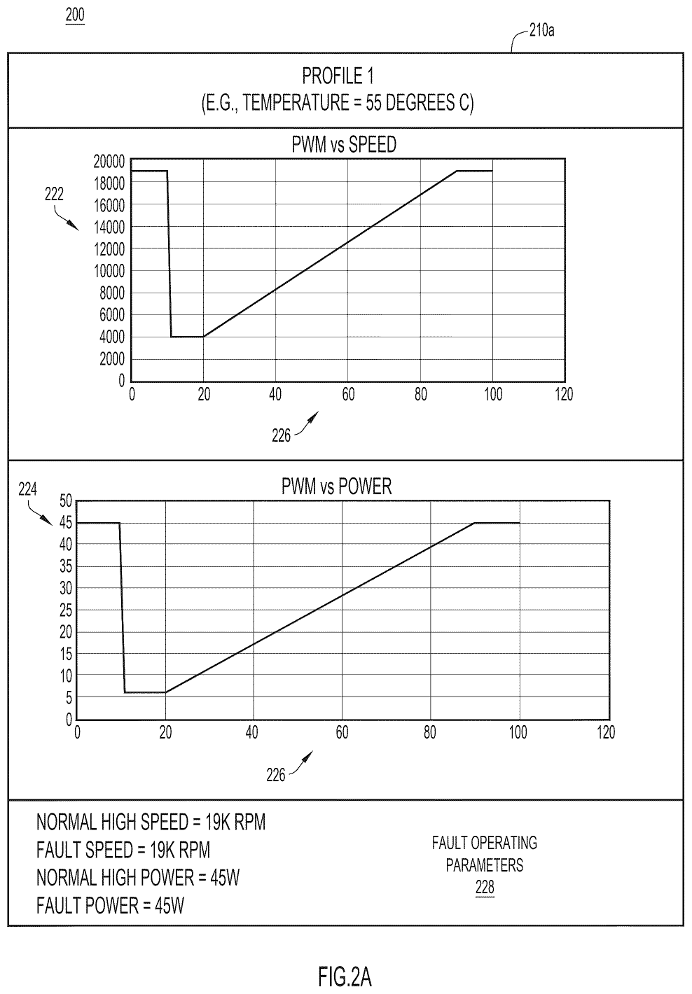

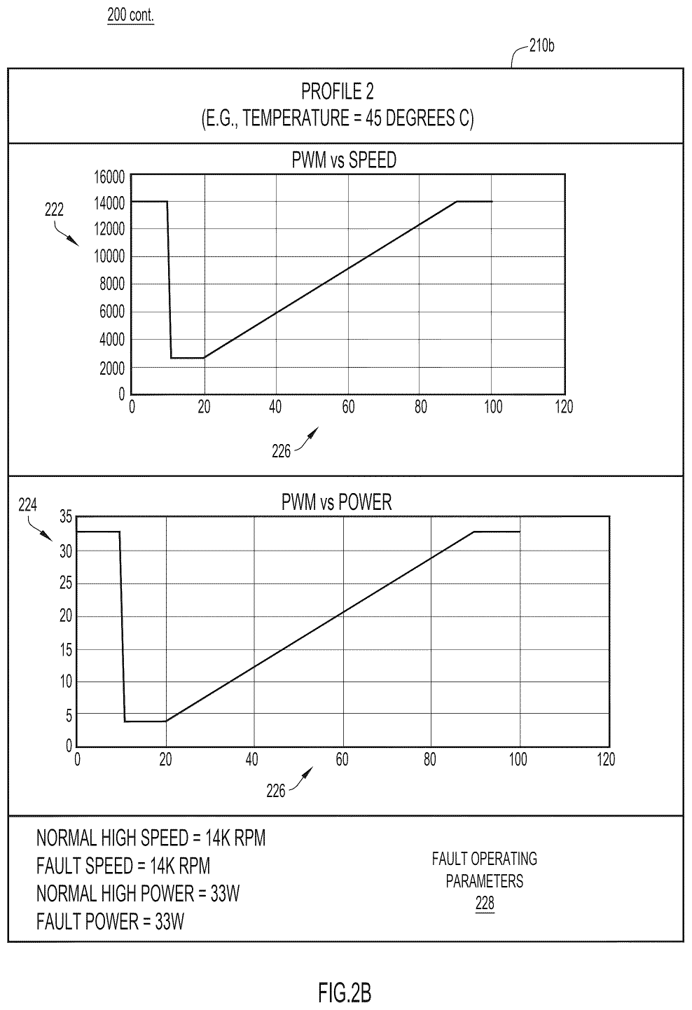

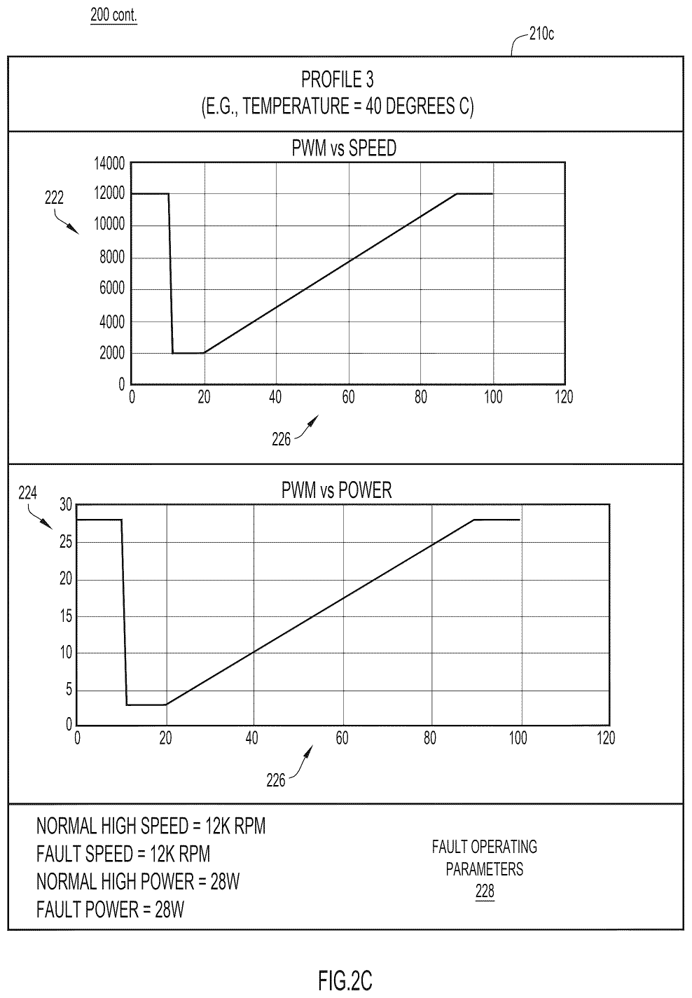

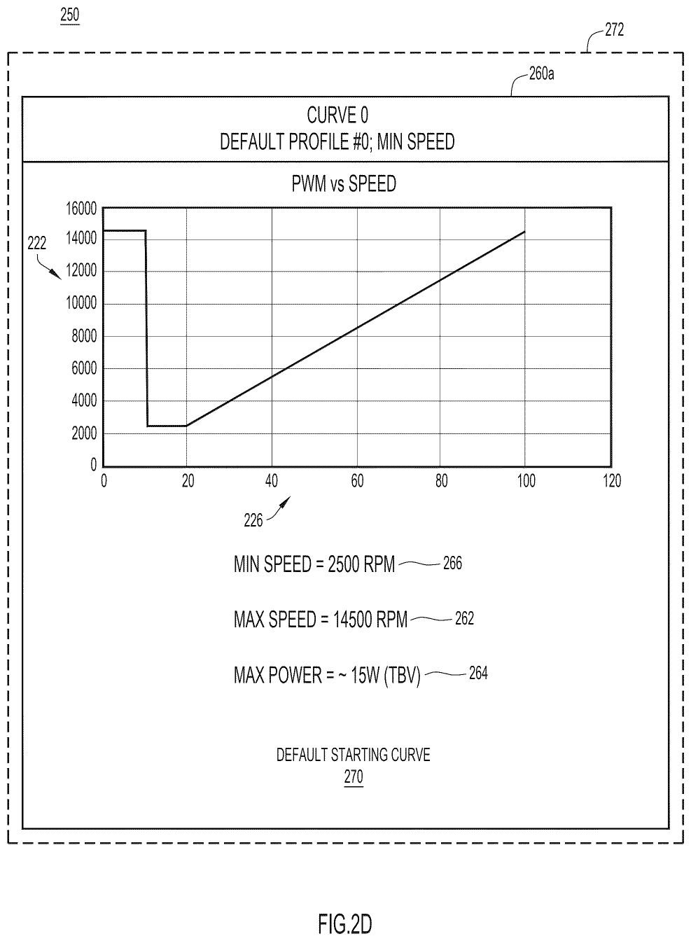

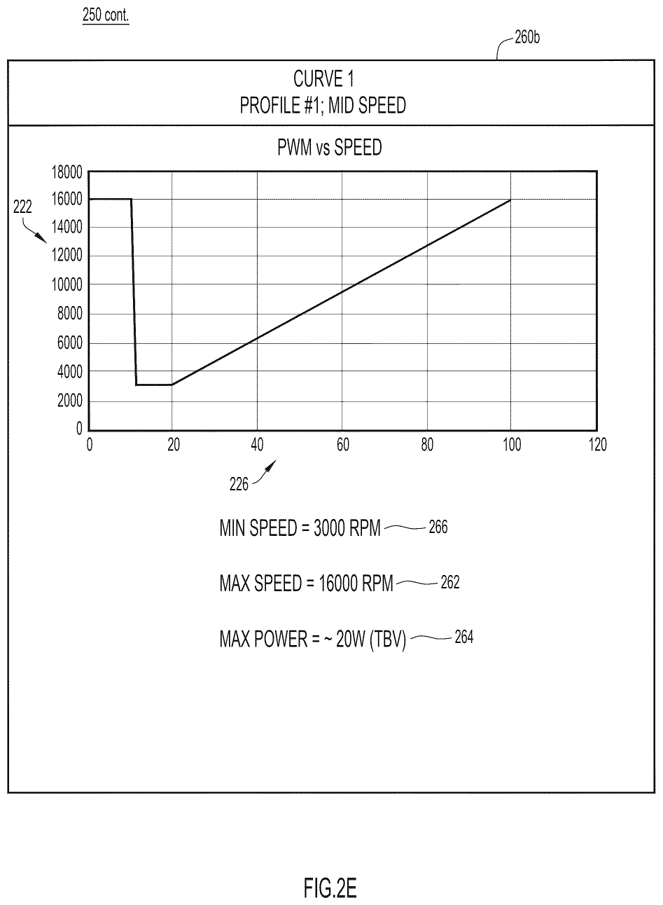

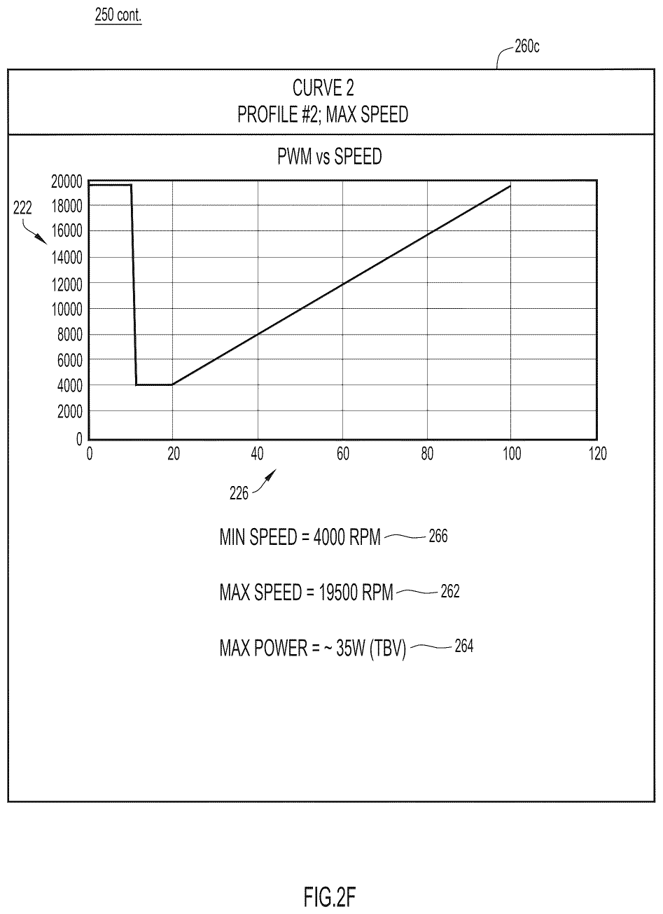

With continued reference to FIG. 1, FIGS. 2A, 2B, 2C, 2D, 2E, and 2F are charts representing operational profiles, which may be available for selection by a fan system of FIG. 1, according to a first example embodiment and a second example embodiment. Specifically, FIGS. 2A, 2B, and 2C illustrate operational profiles in a first operational profile set 200, according to a first example embodiment. FIGS. 2D, 2E, and 2F illustrate operational profiles in a second operational profile set 250, according to a second example embodiment.

Although the first operational profiles set 200 and the second operational profile set 250 illustrate three different operational profiles that are available to be provisioned in the fan 132, it should be noted that any suitable number of operational profiles, such as two operational profiles or more than three operational profiles, may be available to be provisioned in the fan 132, and such operational profiles may define different relationships between PWM duty cycle and fan speed/power.

Specifically, FIGS. 2A, 2B, and 2C illustrate charts representing the first operational profile set 200 that includes multiple profiles for selection by the fan 132 via a digital interface, according to the first example embodiment. FIGS. 2D, 2E, and 2F illustrate charts representing the second operational profile set 250 that has multiple profiles for a selection by the fan 132 via a PWM connection, according to the second example embodiment.

Each operational profile may define 1) a relationship between a pulse width modulated (PWM) duty cycle (in percentage) and speed (in rotations per minute) and 2) a relationship between the PWM duty cycle (in percentage) and power (in Watts (W)). Speed 222 and power 224 are represented on the x-axis and the PWM duty cycle 226 is represented on the y-axis. Each profile may include the second relationship of power consumption to duty cycle because a maximum power needs to be split among various fans/fan trays. Moreover, the operational profiles may be based on power for sustainability reasons. Additionally, each profile may include fault operating parameters such as maximum speed, maximum power, etc.

Specifically, in the first operational profile set 200, each profile includes fault operating parameters 228, selection of which is triggered in the event of failure (when a control signal is below a predetermined threshold e.g., the PWM duty cycle is below 10%). The low control signal (or no control signal) for setting speed/power of the fan within a selected operational profile may be due to a failure of fan tray electronics, a software bug, or a parameter mismatch. When this fault condition occurs, the fan is operated using the fault operating parameters 228 within the selected operational profile. As such, power consumption is improved. That is, instead of operating at maximum speed/power in the event of failure, in one or more example embodiments, the fan is operated based on fault operating parameters 228 within the selected profile. As such, fans used for web server applications type may operate at a substantially lower power in the event of failure.

The first operational profile set 200 includes a first operational profile 210a shown in FIG. 2A, a second operational profile 210b shown in FIG. 2B, and a third operational profile 210c shown in FIG. 2C. In the first operational profile set 200, at each corresponding PWM duty cycle, including a fault condition in which the PWM duty cycle is 10% or less, the first operational profile 210a in FIG. 2A (e.g., implemented when the temperature is limited to 55 degrees Celsius) defines a relationship in which the fan 132 operates at a higher speed and power. The second operational profile 210b in FIG. 2B (e.g., implemented when the temperature is limited to 45 degrees Celsius) defines a relationship in which the fan 132 operates at an intermediate speed and power. The third operational profile 210c in FIG. 2C (e.g., implemented when the temperature is limited to 40 degrees Celsius) defines a relationship in which the fan 132 operates at a still lower speed and power.

The first operational profile 210a may be selected for an application (e.g., related to greater temperature ranges) in which greater fan speed is desirable (e.g., to satisfy greater cooling commands). That is, when the fan 132 is cooling electronic components that run service provider type applications, the first operational profile 210a is selected. The second operational profile 210b may be selected for an application (e.g., a highly controlled environment) in which there is less demand for power and there is a desire for less acoustic noise (and therefore lower fan speed). When the fan 132 is cooling electronic components that execute web type applications, the second operational profile 210b may be selected. The third operational profile 210c may be selected when there are multiple fan trays for example. As such, a specific operational profile may be selected based on the application of the fan 132 (application type).

Each different operational profile may cause the fan 132 to operate at a different speed and power in response to receiving the same PWM signal. As an example, selecting a PWM duty cycle of 80% drives a motor of the fan 132 at a speed of approximately 1,700 rotations per minute (RPM) when the first operational profile 210a of FIG. 2A is selected, at the speed of approximately 1,200 RPM when the second operational profile 210b of FIG. 2B is selected, and at the speed of approximately 1,000 RPM when the third operational profile 210c of FIG. 2C is selected. The PWM duty cycle is a duty cycle modulated signal provided via a PWM connection to drive the fan speed. For example, a frequency generator may generate a signal (square wave) that reflects an actual speed of the fan 132 and may output this signal to the system controller. The system controller may analyze the signal that represents the actual speed of the fan 132 and other signal(s) received from external device(s) (e.g., humidity sensor, temperature sensor, etc.) and adjust the speed of the fan 132 by generating a different PWM duty cycle e.g., set the PWM duty cycle to 60%, 40%, etc.

In the second example embodiment, the PWM duty cycle may also be used to select one of the operational profiles. Specifically, in FIGS. 2D, 2E, and 2F, operational profiles in the second operational profile set 250 are selectable using a PWM connection. The second operational profile set 250 includes a default operational curve 260a in FIG. 2D, a first operational curve 260b in FIG. 2E, and a second operational curve 260c in FIG. 2F. In the second example embodiment, maximum speed 262 and maximum power 264 represent fan speed and power in the event of failure. Also, a minimum speed 266 may be set in each profile. The fan 132 may be manufactured and provided with the default operational curve 260a of FIG. 2D, shown as a default starting curve 270. The fan 132 starts operations using the default operational curve 260a, as shown with the box 272 in FIG. 2D.

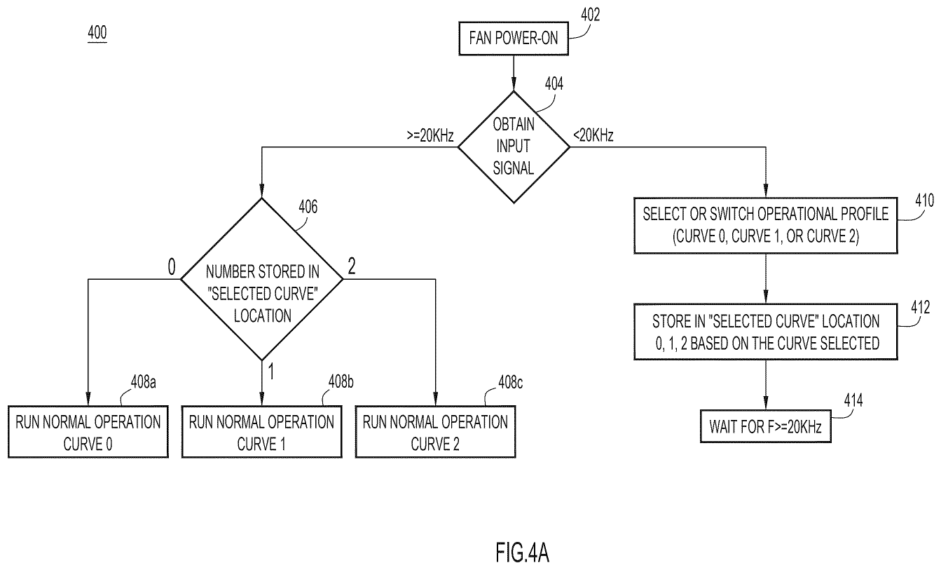

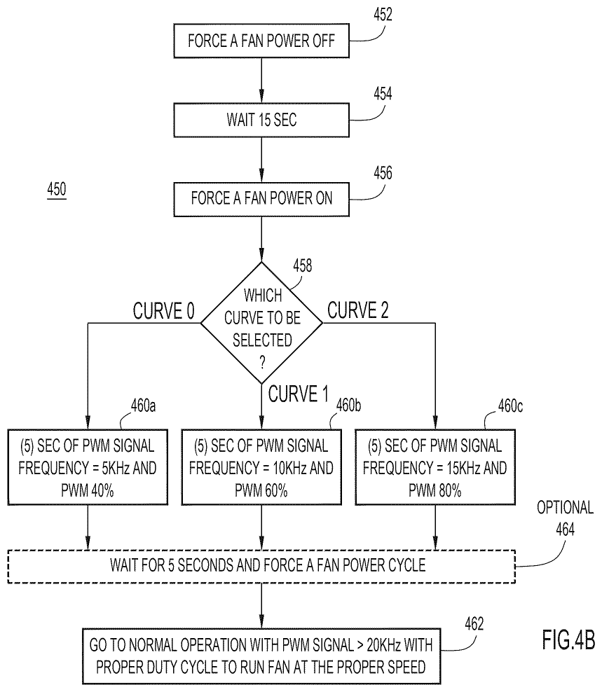

A PWM signal may be used to select another operational profile, e.g., during an initialization phase or a configuration phase, examples of which are shown in FIGS. 4A and 4B. Based on a control signal (e.g., the PWM signal frequency of approximately 5 KHz) being at a PWM duty cycle of 10%-40%, the default operational curve 260a is selected by the fan 132. Based on the control signal (e.g., the PWM signal frequency of approximately 10 KHz) at a PWM duty cycle of 41%-60%, the first operational curve 260b is selected by the fan 132 and based on the control signal (e.g., the PWM signal frequency of approximately 15 KHz) at a PWM duty cycle of 61%-80%, the second operational curve 260c is selected by the fan 132.

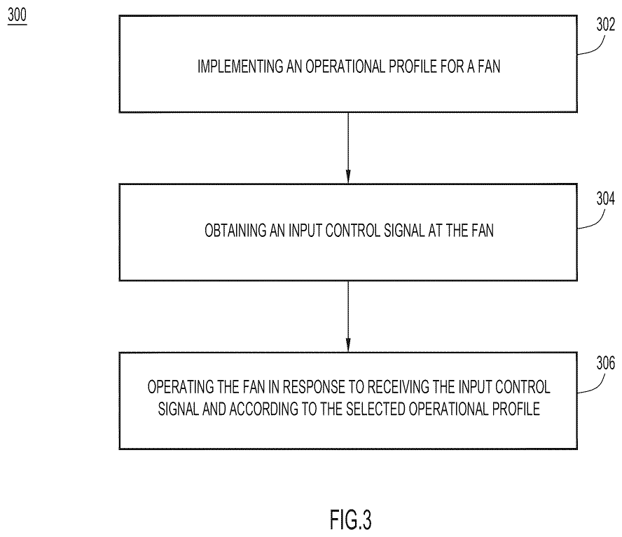

With continued reference to FIGS. 1, 2A, 2B, 2C, 2D, 2E, and 2F, each of FIGS. 3, 4A, 4B, 5, 6, and 7 discussed below is a flowchart of a fan control method. The operations for each method may be performed by a single entity or by multiple entities, and at least a portion of any of the methods may be performed automatically (e.g., by a controller). It should be noted that any of the methods may be performed differently than depicted. For example, an additional operation for any of the methods may be performed, and/or any of the operations in the depicted methods may be performed differently, performed in a different order, and/or not performed. It should further be noted that the respective operations of each method may be performed in any suitable manner with respect to one another, such as sequentially and/or in parallel.

Turning to FIG. 3, FIG. 3 is a flowchart of a method 300 of selecting, via a digital interface, one of operational profiles for controlling operations of the fan, according to the first example embodiment. The method 300 may be performed by the components of the fan 132.

The method 300 involves at 302, implementing an operational profile for the fan 132, such as based on an application of the fan. In some example embodiments, the operational profile is selected from a list of available operational profiles, which may be stored in the fan e.g., in a flash programmable memory inside the fan controller 164. In additional or alternative example embodiments, the operational profile is generated externally and provided to the fan for implementation e.g., loaded onto the fan 132 via the digital interface. In short, the operation 302 may involve obtaining a control signal from the system controller 140 indicative of an operational profile that is to be selected/used by the fan 132.

In one example embodiment, the digital interface 162a may be an I2C interface or I2C bus. In related art, the I2C is a read-only interface for reading fan manufacturing information. In one or more example embodiments, the digital interface 162a is also enabled for writing, such that the control signal may be provided to select a particular profile. In other words, a read and write feature is enabled on I2C bus of the fan 132 such that provisioning may be performed for selecting one of the operational profiles. The provisioning may be performed prior to the use of the fan 132 e.g., during installation. For example, the fan 132 may start with a default operational curve (best performance and maximum power configuration) but at a system startup (initialization phase), the system software is provisioned with a different performance/power configuration (operational profile). The provisioning may involve read current performance/power configuration, write application specific performance/power configuration (application type specific operational profile), and read running configuration. The operational profiles are typically loaded onto the fan 132 prior to operating the fan 132 but this is just one non-limiting example.

The method 300 further involves at 304, obtaining an input control signal by the fan 132 i.e., transmitted from a system controller. For instance, the input control signal may include a PWM signal at a particular frequency and duty cycle, e.g., a duty cycle of 40%, etc.

At 306, the fan 132 then operates in response to receiving the input control signal and according to the selected operational profile. As an example, the operational profile defines a relationship between a fan speed and a value of the input control signal. Therefore, the fan 132 may operate at the fan speed corresponding to the value of the received input control signal. As another example, the operational profile may define a relationship between a fan power and a value of the input control signal to cause the fan 132 to operate at the fan power corresponding to the value of the received input control signal. In any case, because the operational profile is selected based on the application of the fan 132, operation of the fan 132 in response to receiving the input control signal and according to the operational profile may cause the fan 132 to operate more suitably (e.g., at a more suitable fan speed, at a more suitable fan power, etc.) for the application.

As noted above, fans use a PWM signal to drive the fan speed i.e., rotating the motor 168 at a set speed. Frequency generator (FG) output is a signal output by the fan 132 (square wave) that has a frequency related to a real fan speed i.e., sensed speed. In related art, I2C is a read-only interface (I/F) used to read the fan manufacturing data. When system software (SW) sets a specific PWM, the fan runs at the rated speed, and FG provides a reading of the current fan speed. Fan power is also related to its speed. To overcome at least some of the described problems, the techniques presented herein relate to a “provisionable PWM/Speed curve” inside the fan itself. That is, the fan 132 includes the fan controller 164 (e.g., a microcontroller with a flash programmable memory) where the PWM/speed or power curves are stored. The techniques presented herein enable read/write features on the I2C bus of the fan so that provisioning may be performed such that the fan 132 selects a PWM/speed or power curve to use.

With continued reference to FIGS. 1, 2A, 2B, 2C, 2D, 2E, 2F, and 3, FIGS. 4A and 4B are flow diagrams illustrating methods 400 and 450, respectively, for selecting, via a pulse width modulation connection, one of operational profiles for controlling operations of the fan, according to the second example embodiment. The method 400 illustrates operations performed by the fan 132 of FIG. 1 e.g., the fan controller 164 and the method 450 depicts operations performed by the system controller 140 of FIG. 1 e.g., a shelf controller.

The method 400 involves at 402, powering on the fan 132 and at 404, obtaining an input signal. The input signal may be a PWM signal. The fan controller determines the frequency of the input signal. When the frequency of the input signal is above or equal to a predetermined threshold, the fan controller determines that the input signal is a control signal to drive the operations of the fan i.e., control motor speed. That is, the fan 132 is in an operational mode. The fan controller may include one non-volatile location to store the selected curve or operational profile. For example, a default number (location 0) is used to store a selected curve from factory settings corresponding to a low-speed curve (e.g., the default starting curve 270 of FIG. 2B).

When the frequency of the input signal is equal to or above the predetermined threshold, e.g., 20 kHz, at 406, a selected profile/curve is determined. When the selected profile is determined to be curve 0 in the operation 406, at 408a, the fan runs in normal operation based on the curve 0. Specifically, normal operation involves selecting speed/power that corresponds to the input signal based on the selected profile stored in the location. As such, when the selected profile is determined to be curve 1 in the operation 406, at 408b, the fan runs in normal operation based on the curve 1, and when the selected profile is determined to be curve 2 in the operation 406, at 408c, the fan runs in normal operation based on the curve 2.

On the other hand, when the frequency of the input signal is below the predetermined threshold e.g., less than 20 KHz, the fan controller determines that the control signal is to select one of the operational profiles or to switch to a different operational profile. In other words, the input signal triggers a switch of operational profiles and the microcontroller enters a configuration mode/phase or an initialization mode/phase. As such, at 410, an operational profile is selected from a plurality of operational profiles or the fan 132 is switched to operate at a different operational profile. For example, when the PWM signal frequency is 5 kHz+/−10% and the PWM duty cycle is 40%, curve 0 is selected, when the PWM signal frequency is 10 kHz+/−10% and the PWM duty cycle is 60%, curve 1 is selected, and when the PWM signal frequency is 15 kHz+/−10% and the PWM duty cycle is 80%, curve 2 is selected. If the frequency or PWM is different from these noted conditions, the microcontroller exits the configuration mode without changing the previously selected curve. In other words, the selected profile remains unchanged.

The method 400 further involves at 412, storing the selected curve at a specified location (location 0, 1, or 2) based on the curve selected and at 414, waiting for the next input signal i.e., the frequency signal above the predetermined threshold of 20 KHz. That is, the configuration or initialization phase is completed and the fan returns to waiting to obtain the input signal. When the input signal is obtained, the method 400 returns to the operation 404.

At system power up, the system controller 140 generates a PWM signal above a predetermined threshold value (e.g., above 20 KHz) with a duty cycle to run the fan 132 at a proper speed/power within a set operational curve or profile i.e., to run normal operations. On the other hand, when the system controller 140 determines that the selected operational profile needs to be switched or another operation curve is to be selected, the method 450 of FIG. 4B is executed by the system controller 140.

That is, to facilitate the curve selection process, at 452, the system controller 140 forces the fan 132 to power off e.g., by transmitting a control signal via a digital interface, a PWM interface, a power interface, etc. For example, the fan 132 may be powered off by stopping the supply of power from the power supply 120 to the fan 132.

At 454, the system controller 140 starts a timer for a predetermined time period or time interval e.g., 15 seconds and at 456, the system controller 140 transmits another control signal to force the fan 132 to power on e.g., supplies power to the fan 132. At this point, the fan 132 is in the initialization phase or the configuration phase, which has a predetermined duration, e.g., five seconds.

At 458, the system controller 140 determines which operational profile to select prior to the expiration of the predetermined duration. This may be based on an input signal from the external device 150 of FIG. 1, that is, user input, or this may be based on conditions determined by the system controller 140 (humidity, temperature, application type, etc.).

Specifically, in case curve 0 is to be selected, at 460a, the system controller 140 generates a PWM signal at a frequency of 5 kHz and a PWM duty cycle of 40% within this predetermined duration i.e., prior to its expiration. In case curve 1 is to be selected, at 460b, the system controller 140 generates a PWM signal at a frequency of 10 kHz and a PWM duty cycle of 60%, and in case curve 2 is to be selected, at 460c, the system controller 140 generates a PWM signal at a frequency of 15 kHz and PWM duty cycle of 80%. At the end of the predetermined duration e.g., when five seconds expire, the system controller 140 generates a PWM signal above a predetermined threshold value e.g., 20 kHz with a duty cycle to run the fan 132 at the proper speed i.e., resuming normal operations, at 462. Optionally, at 464, after a particular profile is set in the fan 132, the system controller 140 may force the fan to power cycle on and off (e.g., operations 452, 454, and 456). As another variation, switching operational profiles may trigger the fan to power cycle.

As such, a specific profile is selected without the digital interface (the I2C bus). The methods 400 and 450 may be particularly beneficial for smaller fans/fan trays that may not necessarily include the digital interface such as the I2C bus. These fans do not need I2C wires and may module the PWM signal to select an operational curve in the configuration phase or installation phase and then use unmodulated PWM signals for normal speed setting (normal operational mode or phase).

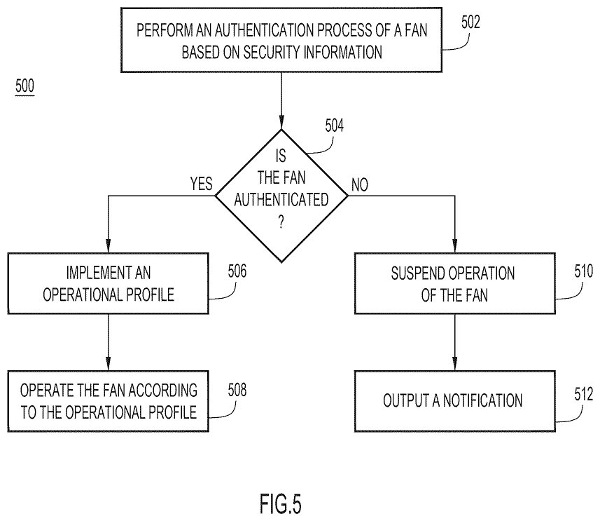

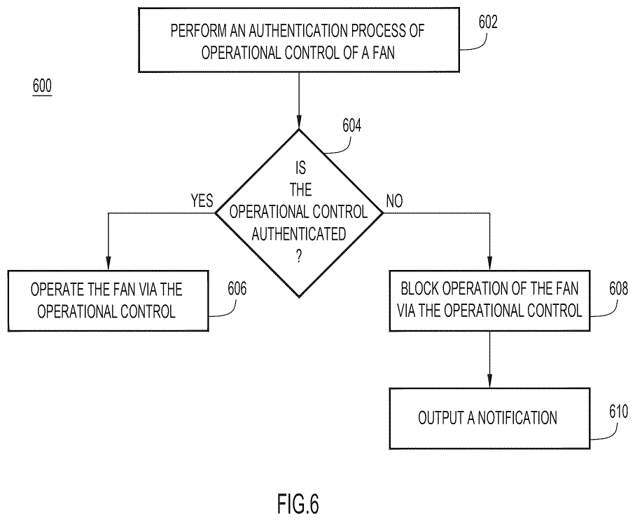

However, a fan that operates using various operational profiles increases security risks. That is, a hacker may load a fake profile onto the fan or control operations of the fan in a way to cause system problems. The techniques presented herein ensure that secure communication is established between the system controller 140 and the fan 132. Additionally, the techniques presented herein authenticate the fan 132 itself for operations, an example of which is in FIGS. 5 and 6.

With continued reference to FIGS. 1, 2A, 2B, 2B, 2C, 2D, 2E, 2F, 3, 4A, and 4B, FIG. 5 is a flowchart of a method 500 for authenticating the fan 132 based on information stored in a trusted platform module, according to an example embodiment. The trusted platform module may be the authentication device 167 of FIG. 1, which stores security information or authentication related information such as an authenticity certificate, private encryption keys, a signature value, a seed value for encryption, a secure identity, a secure identify certificate, etc.

The method 500 is an authentication process in which the fan 132 is authenticated prior to operation, e.g., at installation. That is, installing a new hardware fan or fan tray, may trigger this authentication process. For example, the fan, and more specifically the authentication device 167, may store an authenticity certificate.

During the authentication process, at 502, the identity of the fan may be verified based on the authenticity certificate. At 504, the system controller 140 may determine whether the fan is authenticated. Specifically, in response to a determination that the authenticity certificate is valid (e.g., a match in the signature of the authenticity certificate) in the operation 504, the fan may be authenticated or validated, and operation of the fan may be enabled. Specifically, at 506, an operational profile of the fan may be implemented (selected or set), and at 508, the fan may be operated according to the implemented operational profile.

Optionally, a notification of proper installation and authentication may be output. For example, an LED fan indicator (one of the indicators 180a-d of FIG. 1) may be controlled to turn green. A green light may indicate that the installed new fan has been authenticated and is in a normal operation mode.

However, in response to a determination that the authenticity certificate is invalid (e.g., a mismatch in the signature of the authenticity certificate) in the operation 504, the fan may not be authenticated or validated, and the operation of the fan may be suspended, at 510. In some example embodiments, a notification or alarm may be output, at 512. As an example, an LED fan indicator on the chassis 100 may be controlled to turn yellow, which indicates that the fan is properly installed (LED is not red) but is not authenticated. As another example, the LED fan indicator may be blinking yellow while the authentication is in process.

FIG. 6 is a flowchart depicting a method 600 of authenticating an operational control of the fan 132 of FIG. 1, according to an example embodiment. The method 600 involves verifying an operational control of the fan 132.

Specifically, the method 600 involves at 602, performing an authentication process of an operational control of the fan 132. The operational control may involve selecting one of the operational profiles, installing or updating new operational profiles, and/or controlling the fan 132 by setting certain speed/power within a selected profile.

At 604, a determination is made regarding whether the operational control is authenticated. In response to determining the operational control is authenticated, at 606, the fan is operated via the operational control. However, in response to determining the operational control is not authenticated, at 608, operation of the fan via the operational control is blocked. At 610, a notification or alarm may also be output e.g., a blinking red or yellow LED light may indicate that operation control is not authenticated or validated.

In one or more example embodiments, authenticating the operational control may include verifying the speed of the fan is the expected speed based on the input control signal being provided to the fan (e.g., by the system controller 140). To this end, the current fan speed may be compared to an expected fan speed corresponding to the input control signal (e.g., the input control signal value). The operational control may then be authenticated (“Yes” at operation 604) in response to determining a difference between the current fan speed and the expected fan speed is below a threshold value, whereas the operational control may not be authenticated (“No” at operation 604) in response to determining the difference between the current fan speed and the expected fan speed is above or equal to the threshold value.

By way of an example, a mismatch between the current fan speed and the expected fan speed may indicate that a different input control signal, such as a different input control signal value, may be received by the fan. For instance, the fan is receiving and operating based on an input control signal output by an unintended device (e.g., different from the system controller 140, as intended). To mitigate such operation of the fan based on the input control signal output by the unintended device, the fan may be operated and maintained at a predetermined fan speed (e.g., a high threshold fan speed or a default value triggered by this fault event). For example, the fan controller 164 may implement a new operational profile (or a default parameters of the current operational profile) in which the fan is operated at the predetermined fan speed regardless of the input control signal being received (e.g., by changing operation of the communication bus that transmits the input control signal).

In additional or alternative example embodiments, authenticating the operational control may include authenticating the entity (e.g., the system controller 140, the external device 150) communicatively coupled to the fan. For example, the fan 132 and the system controller 140 establish a secure communication channel using the security information stored in the authentication device 167.

Specifically, the authentication device 167 may store encryption keys to encrypt the communication bus (e.g., establish encrypted or secure digital interface such as I2C encrypted bus), and select entities (e.g., entities having predetermined identifiers) may be able to transmit input control signals to the fan via the encrypted communication bus or the established secure communication connection, whereas other entities may not be able to transmit input control signals to the fan via the encrypted communication bus. As such, authenticating the entity communicatively coupled to the fan may be performed based on the entity being able to transmit input control signals to the fan successfully via the encrypted communication bus i.e., established secure communication interface.

In further example embodiments, authenticating the operational control may include authenticating the operational profile being implemented in the fan. By way of an example, an authorized operational profile may have a signature (e.g., provided by a manufacturer). The authentication device 167 of the fan 132 may be configured to store security information for determining whether the operational profile includes an expected signature (e.g., provided via a private key) to indicate that the operational profile is authorized. The operational profile may be authenticated and implemented in response to determining that the operational profile includes the expected signature, whereas the operational profile may not be authenticated in response to determining that the operational profile does not include the expected signature (e.g., a signature associated with a different private key). The operational profile therefore may not be implemented or installed on the fan upon failure to authenticate.

Further still, in certain example embodiments, the operational profile may be implemented based on performing an authentication process, i.e., the method 600. As an example, information (e.g., an identity) of the entity used for authenticating the entity may also indicate the operational profile to be used by the fan 132. That is, the fan 132 (e.g., the fan controller 164) may authenticate the entity based on such information and, upon authenticating the entity, the fan may select the operational profile based on the information.

In one or more example embodiments, the fan 132 starts with a default PWM/speed or power curve, but at system startup, the system software may securely provision a different PWM/speed or power curve e.g., read current PWM/speed curve, write the application specific PWM/speed curve, and read the running configuration. By establishing a secure communication between the fan 132 and the system controller 140, authenticated control and operations may be performed. The techniques presented herein may authenticate the fan 132, establish a secure communication with the system controller 140 for a secure boot and/or encrypted operational control.

Specifically, the fan 132 has the authentication device 167 on the I2C bus, that stores an authenticity certificate. At system startup, or removal/insertion of the fan 132, the system running software (already protected by secure boot and relevant security features) verifies the authenticity of the fan e.g., by reading security information stored in the authentication device 167. In case of a mismatch, the system controller 140 generates an alarm and stops the system functionality. If the fan is detected to be valid or authenticated, the software provides the right PWM/speed or power curve and enables the features (and operations) of the fan 132.

Additionally, the fan 132 may detect PWM mismatches and switch to a default operational curve. As an example, a hacker physically drives the PWM of the fans in an unexpected way. In this case, the software (e.g., fan controller) detects the mismatch between the set PWM and the running speed of the fan. The configurability to change the operational profile via I2C enables the system to protect itself from high speed and/or extreme power consumption. That is, the system sets the “protection” curve, meaning that 100% of fan speed independently and the PWM is set externally.

To further protect fan 132 from hackers and security attacks, the I2C interface includes a read and write protection, such as an encrypted digital interface where the authentication device 167 stores encryption keys for secure communication by the fan 132 with the system controller 140. Additionally, a secure boot is provided in which, based on the running application, a PWM curve is installed with proper settings. The curve may also be authenticated prior to being installed. This means the operational profile is properly signed e.g., a manufacturer has the private key for the signature. If an unauthorized entity tries to install an operational profile that does not have the signature or is signed with a different private key, it would be identified as an unauthenticated operational profile or curve, and the PWM would not be used. Additionally, the authentication device 167 (e.g., TAM/TPM) may store an X.509 certificate. This guarantees the authenticity of the inserted hardware module.

According to one or more example embodiments, the fan controller 164 may enable installation of a specific operational profile based on information programmed in Secure Identity (SUDI). For example, fan firmware reads an identity of fan controller 164 from the SUDI certificate (after its authentication) and enables the upload of a specific curve or operational profile based on the fan controller identity (i.e., a first fan controller identity enables curve 1 with feature set 1, and a second fan controller enables curve 2 with feature set 2).

The techniques presented herein provide for different operations of a single fan, which may result in a standardization of a single fan to be used for multiple applications i.e., instead of having multiple different specifically designed fans. The techniques presented here enable a system breaker/fuse with a minimum value and specific to a running application to be set. The fan 132 thus is protected against possible vulnerabilities.

In one or more example embodiments, the fan 132 is provisionable through a secure digital interface to configure its cooling/power performances. Thus, the fan 132 has a configurable power consumption in various working conditions. The fan 132 is enabled to have multiple configurable PWM/speed or power curves to support use in different applications (application types) having different cooling constraints. The fan 132 may have a predictable maximum acoustic noise in various working conditions, including system fault. Additionally, a new level of security on the fan 132 is enabled by performing an authenticity check during insertion or installation and by performing a system startup to block an undesirable speed control signal (e.g., PWM). Encryption of the fan control communication bus (establishing a secure communication channel) may also be implemented to reduce communication vulnerability.

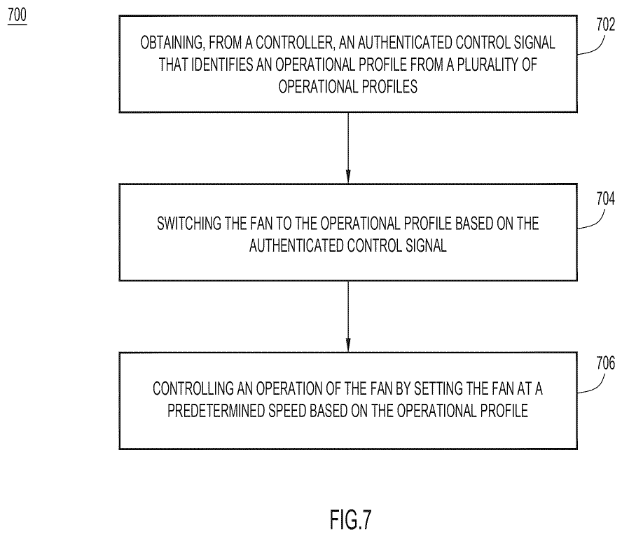

Reference is now made to FIG. 7. FIG. 7 is a flowchart depicting a method 700 of controlling an operation of a fan based on selecting one of operational profiles, according to an example embodiment. The method 700 may be performed by a fan.

At 702, the method 700 involves obtaining, from a controller, an authenticated control signal that identifies an operational profile from a plurality of operational profiles.

At 704, the method 700 includes switching the fan to the operational profile based on the authenticated control signal.

At 706, the method 700 involves controlling an operation of the fan by setting the fan at a predetermined speed based on the operational profile.

In one form, the operation 706 of controlling the operation of the fan may include obtaining, from the controller, a duty cycle signal for varying a speed or power consumption of the fan and setting the fan to the predetermined speed based on the duty cycle signal within the operational profile.

In one instance, the operation 702 of obtaining the authenticated control signal may involve obtaining the authenticated control signal via an encrypted digital interface. Additionally, the operation of obtaining the duty cycle signal may involve obtaining the duty cycle signal provided via a pulse width modulation (PWM) connection.

In another form, the method 700 may further involve authenticating a control signal from the controller using security information stored in the fan and switching the fan to the operational profile based on authenticating the control signal.

In yet another form, the method 700 may further involve performing a secure boot by loading, into the fan, the plurality of operational profiles that have been authenticated. The plurality of operational profiles may include a first operational profile for a first application type and a second operational profile for a second application type different from the first application type.

According to one or more example embodiments, the method 700 may involve storing or loading the plurality of operational profiles into a controller of the fan.

According to one or more example embodiments, the method 700 may include provisioning the fan, by the controller, with a new operational profile via an encrypted communication interface or loading or installing a new operational profile into the fan. The method 700 may further involve authenticating the new operational profile prior to storing the new operational profile in the at least one fan based on an encryption key or an authentication certificate.

According to one or more example embodiments, the method 700 may further include obtaining an authenticated control signal, using a pulse width modulation (PWM) connection, for switching to a different operational profile from the plurality of operational profiles. The authenticated control signal may be a PWM signal frequency.

According to one or more example embodiments, the method 700 may further involve selecting a default operating speed from the operating profile that is triggered in an event of failure/

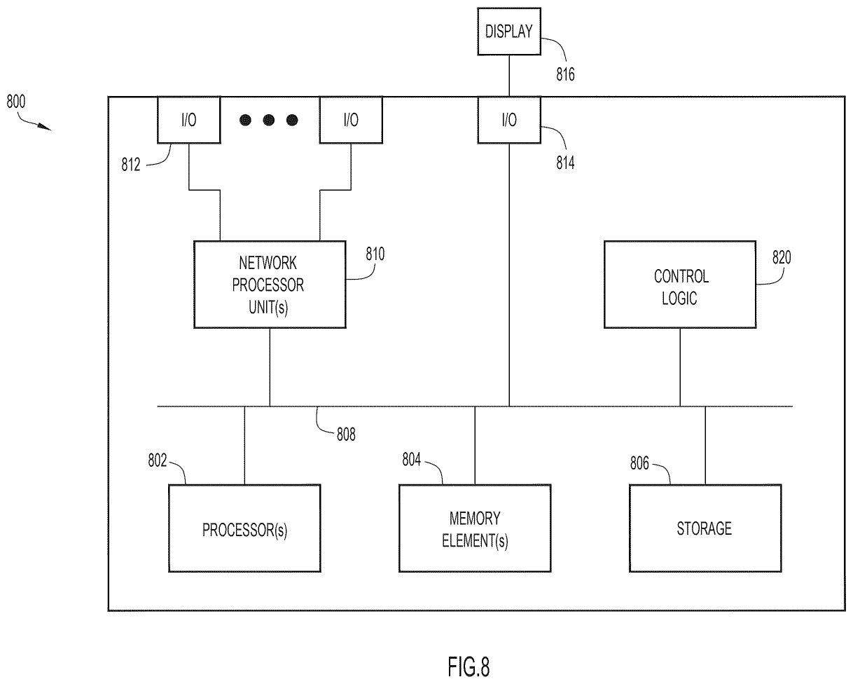

FIG. 8 is a hardware block diagram of a computing device 800 that may perform functions associated with any combination of operations in connection with the techniques depicted and described in FIGS. 1, 2A, 2B, 3, 4A, 4B, and 5-7, according to various example embodiments. The computing device 800 may be a network device that hosts various components to perform at least some of the computing functions. The computing device 800 may be a controller such as system controller 140, an external device such as the external device 150, or the fan controller 164. It should be appreciated that FIG. 8 provides only an illustration of one embodiment and does not imply any limitations with regard to the environments in which different embodiments may be implemented. Many modifications to the depicted environment may be made.

In at least one embodiment, computing device 800 may include one or more processor(s) 802, one or more memory element(s) 804, storage 806, a bus 808, one or more network processor unit(s) 810 interconnected with one or more network input/output (I/O) interface(s) 812, one or more I/O interface(s) 814, and control logic 820. In various embodiments, instructions associated with logic for computing device 800 can overlap in any manner and are not limited to the specific allocation of instructions and/or operations described herein.

In at least one embodiment, processor(s) 802 is/are at least one hardware processor configured to execute various tasks, operations and/or functions for computing device 800 as described herein according to software and/or instructions configured for computing device 800. Processor(s) 802 (e.g., a hardware processor) can execute any type of instructions associated with data to achieve the operations detailed herein. In one example, processor(s) 802 can transform an element or an article (e.g., data, information) from one state or thing to another state or thing. Any of potential processing elements, microprocessors, digital signal processor, baseband signal processor, modem, PHY, controllers, systems, managers, logic, and/or machines described herein can be construed as being encompassed within the broad term ‘processor’.

In at least one embodiment, one or more memory element(s) 804 and/or storage 806 is/are configured to store data, information, software, and/or instructions associated with computing device 800, and/or logic configured for memory element(s) 804 and/or storage 806. For example, any logic described herein (e.g., control logic 820) can, in various embodiments, be stored for computing device 800 using any combination of memory element(s) 804 and/or storage 806. Note that in some embodiments, storage 806 can be consolidated with one or more memory elements 804 (or vice versa), or can overlap/exist in any other suitable manner.

In at least one embodiment, bus 808 can be configured as an interface that enables one or more elements of computing device 800 to communicate in order to exchange information and/or data. Bus 808 can be implemented with any architecture designed for passing control, data and/or information between processors, memory elements/storage, peripheral devices, and/or any other hardware and/or software components that may be configured for computing device 800. In at least one embodiment, bus 808 may be implemented as a fast kernel-hosted interconnect, potentially using shared memory between processes (e.g., logic), which can enable efficient communication paths between the processes.

In various embodiments, network processor unit(s) 810 may enable communication between computing device 800 and other systems, entities, etc., via network I/O interface(s) 812 to facilitate operations discussed for various embodiments described herein. In various embodiments, network processor unit(s) 810 can be configured as a combination of hardware and/or software, such as one or more Ethernet driver(s) and/or controller(s) or interface cards, Fibre Channel (e.g., optical) driver(s) and/or controller(s), and/or other similar network interface driver(s) and/or controller(s) now known or hereafter developed to enable communications between computing device 800 and other systems, entities, etc. to facilitate operations for various embodiments described herein. In various embodiments, network I/O interface(s) 812 can be configured as one or more Ethernet port(s), Fibre Channel ports, and/or any other I/O port(s) now known or hereafter developed. Thus, the network processor unit(s) 810 and/or network I/O interface(s) 812 may include suitable interfaces for receiving, transmitting, and/or otherwise communicating data and/or information in a network environment.

I/O interface(s) 814 allow for input and output of data and/or information with other entities that may be connected to computing device 800. For example, I/O interface(s) 814 may provide a connection to external devices such as a keyboard, keypad, a touch screen, and/or any other suitable input device now known or hereafter developed. In some instances, external devices can also include portable computer readable (non-transitory) storage media such as database systems, thumb drives, portable optical or magnetic disks, and memory cards. In still some instances, external devices can be a mechanism to display data to a user, such as, for example, a computer monitor 816, a display screen, or the like.

In various embodiments, control logic 820 can include instructions that, when executed, cause processor(s) 802 to perform operations, which can include, but not be limited to, providing overall control operations of computing device; interacting with other entities, systems, etc. described herein; maintaining and/or interacting with stored data, information, parameters, etc. (e.g., memory element(s), storage, data structures, databases, tables, etc.); combinations thereof; and/or the like to facilitate various operations for embodiments described herein.

In another example embodiment, an apparatus or a device is provided. The apparatus includes a fan controller configured to store a plurality of operational profiles and a communication interface configured to securely communicate with a system controller to obtain a control signal that enables the fan controller to select an operational profile from the plurality of operational profiles. The apparatus further includes a fan motor configured to rotate to provide cooling to one or more electronic modules that perform one or more operations. The fan controller sets the fan motor to a predetermined speed in the operational profile based on the control signal.

In one form, the apparatus may further include an authentication device that stores security information used for authenticating the control signal. The communication interface may be an encrypted digital interface.

According to one or more example embodiments, the security information may include a certificate for establishing a secure communication interface with the system controller.

In another form, the communication interface may be a pulse width modulation (PWM) connection such that the control signal that identifies the operational profile is provided via a PWM signal frequency during a configuration phase or an installation phase.

In one instance, a duty cycle signal may be provided via the PWM connection to vary a speed or power consumption of the motor within the operational profile.

According to one or more example embodiments, the communication interface may be an inter-integrated circuit interface via which an authenticated control signal is provided to enable the fan controller to switch to a different operational profile from the plurality of operational profiles.

In yet another example embodiment, a system is provided. The system includes one or more electronic modules configured to perform one or more operations and at least one fan configured to cool the one or more electronic modules by operating at a predetermined speed based on an operational profile, The system includes a controller configured to securely communicate with the at least one fan to control the at least one fan to select the operational profile from a plurality of operational profiles.

In one form, the controller may securely provide to the at least one fan, via an encrypted communication interface, a control signal that identifies the operational profile for the at least one fan to select from the plurality of operational profiles.

According to one or more example embodiments, the plurality of operational profiles may include a first operational profile for a first application type and a second operational profile for a second application type different from the first application type.

In one instance, the plurality of operational profiles may include a first operational speed curve for the at least one fan and a second operational speed curve for the at least one fan different from the first operational speed curve.

In another instance, the plurality of operational profiles may include different default operating speeds for the at least one fan. A default operating speed may be triggered in an event of failure.

In another form, the controller may provide, via an inter-integrated circuit interface, to the at least one fan, a control signal to select the operational profile from the plurality of operational profiles.

In one instance, the controller may provide, using a pulse width modulation (PWM) connection, to the at least one fan, a control signal to select the operational profile from the plurality of operational profiles. The control signal may be provided during an initialization phase of the at least one fan or a configuration phase with the at least one fan.

In yet another form, the controller may further be configured to provision the at least one fan with a new operational profile via an encrypted communication interface. The at least one fan may be configured to authenticate the new operational profile prior to storing the new operational profile in the at least one fan based on an encryption key or an authentication certificate.

According to one or more example embodiments, the system may further include a fan tray that includes the at least one fan and at least one other fan, each of which may be configured with the plurality of operational profiles.

In one instance, the controller may provide to the at least one fan, via an inter-integrated circuit interface, an authenticated control signal for switching to a different operational profile from the plurality of operational profiles.

In another instance, the controller may provide an authenticated control signal, using a pulse width modulation (PWM) connection, for switching to a different operational profile from the plurality of operational profiles. The authenticated control signal may be a PWM signal frequency.

According to one or more example embodiments, the at least one fan may include a trusted platform module that stores security information. The at least one fan may be configured to authenticate a control signal from the controller based on the security information and may be configured to provide the security information to establish secure communication with the controller.

In one form, the system may further include a power supply that is configured to supply power to the controller, the at least one fan, and the one or more electronic modules. The at least one fan may include a trusted platform module that stores an authentication certificate for checking and validating an authenticity of a hardware in the at least one fan prior to enabling operations of the at least one fan. Based on a failure of an authenticity process of the hardware in the at least one fan, the controller may generate an alarm and disable the at least one fan by shutting down the power from the power supply.

In yet another example embodiment, an arrangement may be provided that includes the devices and operations explained above with reference to FIGS. 1-8.

The programs described herein (e.g., control logic 820) may be identified based upon the application(s) for which they are implemented in a specific embodiment. However, it should be appreciated that any particular program nomenclature herein is used merely for convenience, and thus the embodiments herein should not be limited to use(s) solely described in any specific application(s) identified and/or implied by such nomenclature.

In various embodiments, entities as described herein may store data/information in any suitable volatile and/or non-volatile memory item (e.g., magnetic hard disk drive, solid state hard drive, semiconductor storage device, random access memory (RAM), read only memory (ROM), erasable programmable read only memory (EPROM), application specific integrated circuit (ASIC), etc.), software, logic (fixed logic, hardware logic, programmable logic, analog logic, digital logic), hardware, and/or in any other suitable component, device, element, and/or object as may be appropriate. Any of the memory items discussed herein should be construed as being encompassed within the broad term ‘memory element’. Data/information being tracked and/or sent to one or more entities as discussed herein could be provided in any database, table, register, list, cache, storage, and/or storage structure: all of which can be referenced at any suitable timeframe. Any such storage options may also be included within the broad term ‘memory element’ as used herein.

Note that in certain example implementations, operations as set forth herein may be implemented by logic encoded in one or more tangible media that is capable of storing instructions and/or digital information and may be inclusive of non-transitory tangible media and/or non-transitory computer readable storage media (e.g., embedded logic provided in: an ASIC, digital signal processing (DSP) instructions, software [potentially inclusive of object code and source code], etc.) for execution by one or more processor(s), and/or other similar machine, etc. Generally, the storage 806 and/or memory elements(s) 804 can store data, software, code, instructions (e.g., processor instructions), logic, parameters, combinations thereof, and/or the like used for operations described herein. This includes the storage 806 and/or memory elements(s) 804 being able to store data, software, code, instructions (e.g., processor instructions), logic, parameters, combinations thereof, or the like that are executed to carry out operations in accordance with teachings of the present disclosure.

In some instances, software of the present embodiments may be available via a non-transitory computer useable medium (e.g., magnetic or optical mediums, magneto-optic mediums, CD-ROM, DVD, memory devices, etc.) of a stationary or portable program product apparatus, downloadable file(s), file wrapper(s), object(s), package(s), container(s), and/or the like. In some instances, non-transitory computer readable storage media may also be removable. For example, a removable hard drive may be used for memory/storage in some implementations. Other examples may include optical and magnetic disks, thumb drives, and smart cards that can be inserted and/or otherwise connected to a computing device for transfer onto another computer readable storage medium.

### Variations and Implementations

Embodiments described herein may include one or more networks, which can represent a series of points and/or network elements of interconnected communication paths for receiving and/or transmitting messages (e.g., packets of information) that propagate through the one or more networks. These network elements offer communicative interfaces that facilitate communications between the network elements. A network can include any number of hardware and/or software elements coupled to (and in communication with) each other through a communication medium. Such networks can include, but are not limited to, any local area network (LAN), virtual LAN (VLAN), wide area network (WAN) (e.g., the Internet), software defined WAN (SD-WAN), wireless local area (WLA) access network, wireless wide area (WWA) access network, metropolitan area network (MAN), Intranet, Extranet, virtual private network (VPN), Low Power Network (LPN), Low Power Wide Area Network (LPWAN), Machine to Machine (M2M) network, Internet of Things (IoT) network, Ethernet network/switching system, any other appropriate architecture and/or system that facilitates communications in a network environment, and/or any suitable combination thereof.

Networks through which communications propagate can use any suitable technologies for communications including wireless communications (e.g., 4G/5G/nG, IEEE 802.11 (e.g., Wi-Fi®/Wi-Fi6®), IEEE 802.16 (e.g., Worldwide Interoperability for Microwave Access (WiMAX)), Radio-Frequency Identification (RFID), Near Field Communication (NFC), Bluetooth™ mm.wave, Ultra-Wideband (UWB), etc.), and/or wired communications (e.g., T1 lines, T3 lines, digital subscriber lines (DSL), Ethernet, Fibre Channel, etc.). Generally, any suitable means of communications may be used such as electric, sound, light, infrared, and/or radio to facilitate communications through one or more networks in accordance with embodiments herein. Communications, interactions, operations, etc. as discussed for various embodiments described herein may be performed among entities that may directly or indirectly connected utilizing any algorithms, communication protocols, interfaces, etc. (proprietary and/or non-proprietary) that allow for the exchange of data and/or information.

Communications in a network environment can be referred to herein as ‘messages’, ‘messaging’, ‘signaling’, ‘data’, ‘content’, ‘objects’, ‘requests’, ‘queries’, ‘responses’, ‘replies’, etc. which may be inclusive of packets. As referred to herein and in the claims, the term ‘packet’ may be used in a generic sense to include packets, frames, segments, datagrams, and/or any other generic units that may be used to transmit communications in a network environment. Generally, a packet is a formatted unit of data that can contain control or routing information (e.g., source and destination address, source and destination port, etc.) and data, which is also sometimes referred to as a ‘payload’, ‘data payload’, and variations thereof. In some embodiments, control or routing information, management information, or the like can be included in packet fields, such as within header(s) and/or trailer(s) of packets. Internet Protocol (IP) addresses discussed herein and in the claims can include any IP version 4 (IPv4) and/or IP version 6 (IPv6) addresses.

To the extent that embodiments presented herein relate to the storage of data, the embodiments may employ any number of any conventional or other databases, data stores or storage structures (e.g., files, databases, data structures, data or other repositories, etc.) to store information.

Note that in this Specification, references to various features (e.g., elements, structures, nodes, modules, components, engines, logic, steps, operations, functions, characteristics, etc.) included in ‘one embodiment’, ‘example embodiment’, ‘an embodiment’, ‘another embodiment’, ‘certain embodiments’, ‘some embodiments’, ‘various embodiments’, ‘other embodiments’, ‘alternative embodiment’, and the like are intended to mean that any such features are included in one or more embodiments of the present disclosure, but may or may not necessarily be combined in the same embodiments. Note also that a module, engine, client, controller, function, logic or the like as used herein in this Specification, can be inclusive of an executable file comprising instructions that can be understood and processed on a server, computer, processor, machine, compute node, combinations thereof, or the like and may further include library modules loaded during execution, object files, system files, hardware logic, software logic, or any other executable modules.

It is also noted that the operations and steps described with reference to the preceding figures illustrate only some of the possible scenarios that may be executed by one or more entities discussed herein. Some of these operations may be deleted or removed where appropriate, or these steps may be modified or changed considerably without departing from the scope of the presented concepts. In addition, the timing and sequence of these operations may be altered considerably and still achieve the results taught in this disclosure. The preceding operational flows have been offered for purposes of example and discussion. Substantial flexibility is provided by the embodiments in that any suitable arrangements, chronologies, configurations, and timing mechanisms may be provided without departing from the teachings of the discussed concepts.

As used herein, unless expressly stated to the contrary, use of the phrase ‘at least one of’, ‘one or more of’, ‘and/or’, variations thereof, or the like are open-ended expressions that are both conjunctive and disjunctive in operation for any and all possible combination of the associated listed items. For example, each of the expressions ‘at least one of X, Y and Z’, ‘at least one of X, Y or Z’, ‘one or more of X, Y and Z’, ‘one or more of X, Y or Z’ and ‘X, Y and/or Z’ can mean any of the following: 1) X, but not Y and not Z; 2) Y, but not X and not Z; 3) Z, but not X and not Y; 4) X and Y, but not Z; 5) X and Z, but not Y; 6) Y and Z, but not X; or 7) X, Y, and Z.

Additionally, unless expressly stated to the contrary, the terms ‘first’, ‘second’, ‘third’, etc., are intended to distinguish the particular nouns they modify (e.g., element, condition, node, module, activity, operation, etc.). Unless expressly stated to the contrary, the use of these terms is not intended to indicate any type of order, rank, importance, temporal sequence, or hierarchy of the modified noun. For example, ‘first X’ and ‘second X’ are intended to designate two ‘X’ elements that are not necessarily limited by any order, rank, importance, temporal sequence, or hierarchy of the two elements. Further as referred to herein, ‘at least one of’ and ‘one or more of’ can be represented using the ‘(s)’ nomenclature (e.g., one or more element(s)).

Each example embodiment disclosed herein has been included to present one or more different features. However, all disclosed example embodiments are designed to work together as part of a single larger system or method. This disclosure explicitly envisions compound embodiments that combine multiple previously-discussed features in different example embodiments into a single system or method.

One or more advantages described herein are not meant to suggest that any one of the embodiments described herein necessarily provides all of the described advantages or that all the embodiments of the present disclosure necessarily provide any one of the described advantages. Numerous other changes, substitutions, variations, alterations, and/or modifications may be ascertained to one skilled in the art and it is intended that the present disclosure encompass all such changes, substitutions, variations, alterations, and/or modifications as falling within the scope of the appended claims.

What is claimed is:

1. A system comprising:
one or more electronic modules configured to perform one or more operations;
at least one fan configured to cool the one or more electronic modules by operating at a predetermined speed based on an operational profile; and
a controller configured to securely communicate with the at least one fan to control the at least one fan to select the operational profile from a plurality of operational profiles.

2. The system of claim 1, wherein the controller securely provides to the at least one fan, via an encrypted communication interface, a control signal that identifies the operational profile for the at least one fan to select from the plurality of operational profiles.

3. The system of claim 1, wherein the plurality of operational profiles include a first operational profile for a first application type and a second operational profile for a second application type different from the first application type.

4. The system of claim 1, wherein the plurality of operational profiles include a first operational speed curve for the at least one fan and a second operational speed curve for the at least one fan different from the first operational speed curve.

5. The system of claim 1, wherein the plurality of operational profiles include different default operating speeds for the at least one fan, wherein a default operating speed is triggered in an event of failure.

6. The system of claim 1, wherein the controller provides, via an inter-integrated circuit interface, to the at least one fan, a control signal to select the operational profile from the plurality of operational profiles.

7. The system of claim 1, wherein the controller provides, using a pulse width modulation (PWM) connection, to the at least one fan, a control signal to select the operational profile from the plurality of operational profiles, wherein the control signal is provided during an initialization phase of the at least one fan or a configuration phase with the at least one fan.

8. The system of claim 1, wherein the controller is further configured to provision the at least one fan with a new operational profile via an encrypted communication interface, and wherein the at least one fan is configured to authenticate the new operational profile prior to storing the new operational profile in the at least one fan based on an encryption key or an authentication certificate.

9. The system of claim 1, further comprising:
a fan tray that includes the at least one fan and at least one other fan, each of which are configured with the plurality of operational profiles.

10. The system of claim 1, wherein the controller provides to the at least one fan, via an inter-integrated circuit interface, an authenticated control signal for switching to a different operational profile from the plurality of operational profiles.

11. The system of claim 1, wherein the controller provides an authenticated control signal, using a pulse width modulation (PWM) connection, for switching to a different operational profile from the plurality of operational profiles, and wherein the authenticated control signal is a PWM signal frequency.

12. The system of claim 1, wherein the at least one fan includes a trusted platform module that stores security information, and wherein the at least one fan is configured to authenticate a control signal from the controller based on the security information and is configured to provide the security information to establish secure communication with the controller.

13. The system of claim 1, further comprising:
a power supply configured to supply power to the controller, the at least one fan, and the one or more electronic modules,
wherein the at least one fan includes a trusted platform module that stores an authentication certificate for checking and validating an authenticity of a hardware in the at least one fan prior to enabling operations of the at least one fan, and
wherein, based on a failure of an authenticity process of the hardware in the at least one fan, the controller generates an alarm and disables the at least one fan by shutting down the power from the power supply.

14. A method performed by a fan, the method comprising:
obtaining, from a controller, an authenticated control signal that identifies an operational profile from a plurality of operational profiles;
switching the fan to the operational profile based on the authenticated control signal; and
controlling an operation of the fan by setting the fan at a predetermined speed based on the operational profile.

15. The method of claim 14, wherein controlling the operation of the fan further comprises:
obtaining, from the controller, a duty cycle signal for varying a speed or power consumption of the fan; and
setting the fan to the predetermined speed based on the duty cycle signal within the operational profile.

16. The method of claim 15, wherein obtaining the authenticated control signal includes obtaining the authenticated control signal via an encrypted digital interface and wherein obtaining the duty cycle signal includes obtaining the duty cycle signal provided via a pulse width modulation (PWM) connection.

17. The method of claim 14, further comprising:
authenticating a control signal from the controller using security information stored in the fan; and
switching the fan to the operational profile based on authenticating the control signal.

18. The method of claim 14, further comprising:
performing a secure boot by loading, into the fan, the plurality of operational profiles that have been authenticated,
wherein the plurality of operational profiles include a first operational profile for a first application type and a second operational profile for a second application type different from the first application type.

19. An apparatus comprising:
a fan controller configured to store a plurality of operational profiles;
a communication interface configured to securely communicate with a system controller to obtain a control signal that enables the fan controller to select an operational profile from the plurality of operational profiles; and
a fan motor configured to rotate to provide cooling to one or more electronic modules that perform one or more operations,
wherein the fan controller sets the fan motor to a predetermined speed in the operational profile based on the control signal.

20. The apparatus of claim 19, further comprising:
an authentication device that stores security information used for authenticating the control signal, and wherein the communication interface is an encrypted digital interface.
